(19) United States
(12) Patent Application Publication
(10) Pub. No.: US 2010/0133376 A1
(43) Pub. Date: Jun. 3, 2010

(54) AIRCRAFT ENGINE MOUNTING PYLON COMPRISING A TAPERED SHIM TO SECURE THE FORWARD ENGINE ATTACHMENT

(75) Inventors: Laurent Foyer, Saint Sulpice (FR); Fabien Menou, Toulouse (FR); Stephane Combes, Buzet Sur Tarn (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus Operations, Toulouse (FR)

(21) Appl. No.: 12/598,649

(22) PCT Filed: May 21, 2008
(86) PCT No.: PCT/EP08/56238

§ 371 Date: Nov. 3, 2009

(30) Foreign Application Priority Data
May 23, 2007 (FR) 07 55211

(51) Int. Cl. B64D 27/26

(52) U.S. Cl. 244/54

(57) ABSTRACT

A mounting pylon for an aircraft engine. The pylon includes a rigid structure forming a box including an inclined lower spar and an upper spar, and an engine mounting system mounted fixedly on the structure and including a forward attachment including an attachment body including a horizontal securing surface lying flat against a horizontal securing surface of the rigid structure. The horizontal securing surface of the rigid structure is defined by a tapered shim mounted on the inclined lower spar, externally relative to the box.

### TECHNICAL AREA

The present invention generally relates to an aircraft engine assembly, of the type comprising an engine, a pylon and an engine mounting system provided with a plurality of engine attachments and being positioned between a rigid structure of the pylon and the engine.

The invention also relates to said pylon for mounting an aircraft engine.

The invention can be used on any type of aircraft equipped with turbojet or turbo-prop engines for example.

This type of pylon, also called “EMS” for Engine Mounting Structure is used for example to mount a turbojet engine underneath an aircraft wing, or to mount this turbojet engine over this same wing.

### STATE OF THE PRIOR ART

Said pylon is effectively provided to form a connecting interface between an engine such as a turbojet engine and an aircraft wing. It allows loads generated by its associated turbojet engine to be transmitted to the frame of this aircraft, and also provides a pathway for fuel, electric, hydraulic, and air supply lines between the engine and the aircraft.

To ensure load transmission, the pylon comprises a rigid structure often of “box” type i.e. formed by the assembly of upper and lower spars and of two side panels joined together via transverse ribs.

Also, the pylon is provided with an engine mounting system, positioned between the turbojet and the rigid structure of the pylon, this system globally comprising at least two engine attachments, generally a forward attachment and an aft attachment.

Additionally, the mounting system comprises a device to transmit thrust loads generated by the turbojet. In the prior art this device is in the form of two side thrust links for example, connected firstly to an aft part of the fan case of the turbojet and secondly to the aft engine attachment secured to the engine case.

Similarly, the pylon also comprises a second mounting system positioned between the rigid structure of this pylon and the aircraft wing, this second system usually consisting of two or three attachments.

Finally, the pylon is provided with a secondary structure to separate and support the supply lines, whilst carrying aerodynamic cowling.

In some prior art embodiments, the engine mounting system comprises a forward attachment, called a fan attachment since it is intended to be fixedly mounted on the fan case of the engine, which comprises an attachment body having a horizontal securing surface lying flat against a horizontal securing surface of the rigid structure. The horizontal securing interface formed by these two surfaces, therefore extends along a plane defined by the longitudinal and transverse directions of the pylon, and generally lies at an outer surface of the lower spar of the box if the engine is intended to be mounted under the aircraft wing. The attachment body of the engine attachment is generally secured to the lower spar of the box, being arranged under this spar.

This arrangement has a non-negligible disadvantage, which is that the front end of the lower spar must be arranged horizontally so as, at least partly, to form the above-mentioned securing surface. However this necessarily generates the presence of a break on the lower spar, since this spar then extends afterward at an angle relative to the horizontal, in particular so that it can draw close to the exhaust case to allow installation of the aft engine attachment secured to this same case or in the vicinity thereof.

The presence of the break on the lower spar leads to the onset of major mechanical stresses at this point, possibly requiring over-sizing of some parts of the pylon, which is penalizing in terms of cost and weight.

### SUMMARY OF THE INVENTION

The purpose of the invention is therefore to propose a pylon for an aircraft engine, which overcomes the above-mentioned disadvantage of prior art embodiments.

For this purpose, the subject of the invention is a mounting pylon for aircraft engine, said pylon comprising a rigid structure forming a box provided with a spar that is inclined relative to the horizontal, and an engine mounting system fixedly mounted on said rigid structure and notably comprising a forward engine attachment comprising an attachment body provided with a horizontal securing surface lying flat against a horizontal securing surface of said rigid structure. According to the invention, said horizontal securing surface of said rigid structure is defined by a tapered shim mounted on said inclined spar, externally relative to said box.

Advantageously, it arises from the definition of the invention given above that the rigid structure has been modified compared with those previously encountered, so that the horizontal securing surface defined by the rigid structure and intended to receive the attachment body of the forward attachment, is no longer defined by the outer surface of the spar of the box, but by a tapered shim added to this same outer surface. By way of indication, in the preferred case in which the pylon is intended to ensure mounting of the engine below the aircraft wing, the spar concerned is the lower spar of the box, which is inclined relative to the horizontal so that it draws close to the axis of the engine in the aft direction, to allow securing of the aft engine attachment.

With the invention, it is therefore advantageously possible not to require a break in the lower spar at its forward end, since the forming of the horizontal securing surface of the rigid structure is astutely achieved with the tapered shim, fixedly attached below this lower inclined spar. Therefore, the entire forward part of the inclined lower spar can be planar, and preferably the entire part of the lower spar located between the forward engine attachment and the aft engine attachment. Further preferably, it is the entirety of the inclined lower spar which is planar, namely from one end to the other of the rigid structure in the longitudinal direction of the pylon.

The absence of a break on the spar ensures better load transmission through the box structure, and allows a planar spar to be produced that is easier and less costly to manufacture than a spar with a break.

Preferably, the horizontal securing surface of the rigid structure consists entirely of the tapered shim which, for example, has three or four bearing points to define this surface. The bearing points provided on the shim offer extremely satisfactory planarity characteristics. In addition, the horizontal securing surface of the rigid structure preferably extends entirely beneath the inclined lower spar, without projecting laterally from the spar. This advantageously makes it possible not to increase the width of the forward end of the box structure, and hence not to incur any aerodynamic penalisation of the pylon.

Also, the height of the forward end of the box structure can also be kept to a relatively low height, leading to a pylon of simple design and of compact appearance, only generating very little aerodynamic disturbance.

Preferably, said rigid structure comprises a forward closing rib of the box, means to secure the tapered shim onto said inclined spar passing through said forward closing rib. This particular aspect makes it possible to ensure excellent passing of loads into the box, since they are directly injected into the forward closing rib.

Preferably, said means to secure the tapered shim onto said inclined spar comprise vertical tension bolts successively passing through the attachment body, the tapered shim, said inclined spar, and the forward closing rib of the box. Nonetheless, it is to be noted that these vertical tension bolts essentially allow the connection to be made between the forward engine attachment and the rigid structure of the pylon, and they indirectly take part in the joining of the tapered shim onto the inclined spar.

Also, said forward engine attachment comprises at least one vertical shear pin successively passing through the attachment body, the tapered shim, said inclined spar and the forward closing rib of the box.

As mentioned previously, in the preferred case in which the pylon is intended to ensure the mounting of the engine below the aircraft wing, the spar concerned is the inclined lower spar of the box. Evidently, in the other case in which the engine is intended to be mounted over the wing, the spar concerned is the inclined upper spar of the box, the spar concerned effectively always being the one of the two that is closest to the engine and carrying the engine attachments.

Preferably, the forward closing rib of the box has a lower sidewall lying flat against a forward end of the inclined lower spar, and an upper sidewall lying flat against a forward end of an upper spar of the rigid box-forming structure.

In this case, provision is made so that said forward end of the inclined lower spar extends forwardly beyond said forward end of the upper spar, the axes of the vertical tension bolts being such that they pass through said forward end of the lower spar without passing through said forward end of the upper spar. This specificity facilitates the clamping operation of the bolts since the forward end of the upper spar, offset aftward, offers no hindrance against performing this clamping from overhead.

Preferably, the forward engine attachment is designed so as to ensure transmission of the loads exerted in a transverse direction of the pylon and in the vertical direction thereof.

Also, the engine mounting system, which is preferably an isostatic system, further comprises a device to transmit thrust loads as well as an aft engine attachment designed to ensure transmission of loads exerted in the transverse and vertical directions of the pylon.

A further subject of the invention is an aircraft engine assembly comprising a pylon such as just presented, and an engine secured to this pylon.

Finally, a subject of the invention is an aircraft comprising at least one said engine assembly.

Other advantages and characteristics of the invention will become apparent in the detailed, non-limiting description given below.

### BRIEF DESCRIPTION OF THE DRAWINGS

This description will be made with reference to the appended drawings among which:

FIG. 1 shows a partial side-view schematic of an aircraft engine assembly comprising a pylon according to one preferred embodiment of the present invention;

FIG. 2 is a perspective view schematising the load transmission ensured by the engine mount system equipping the pylon shown FIG. 1;

FIG. 3 is a detailed, perspective view of the forward part of the pylon shown FIG. 1;

FIG. 4 is an exploded view of the illustration shown FIG. 3, from a different viewpoint;

FIG. 5 gives a cross-sectional view passing through plane P1 of FIG. 3;

FIG. 6 gives a cross-sectional view passing through plane P2 of FIG. 3;

FIG. 7 is a detailed, perspective view of the forward part of a pylon according to another preferred embodiment;

FIG. 8 is an exploded view of the illustration shown FIG. 7, from a different viewpoint;

FIG. 9 is a cross-sectional view passing through plane P3 of FIG. 7; and

FIG. 10 is a cross-sectional view passing through plane P4 of FIG. 7.

### DETAILED DESCRIPTION OF PREFERRED EMBODIMENTS

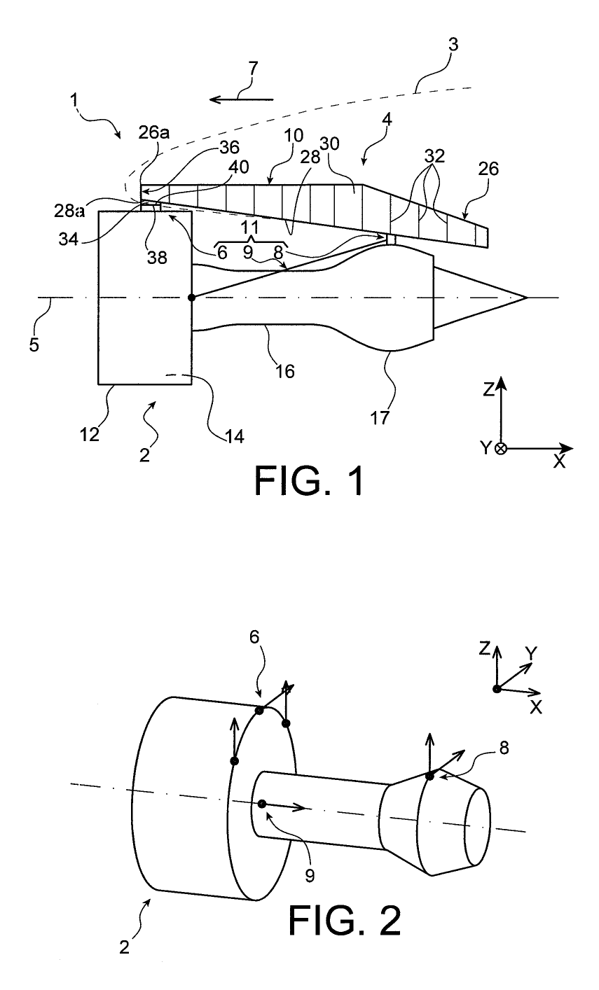

With reference to FIG. 1, an aircraft engine assembly 1 can be seen, intended to be attached below a wing 3 of this aircraft, this assembly 1 subject of the present invention being provided with a pylon 4 in the form of a preferred embodiment of the present invention.

Globally, the engine assembly 1 comprises an engine such as a turbojet engine 2 and the pylon 4, this pylon notably being provided with a rigid structure 10 and with an engine mounting system 11 consisting of a plurality of engine attachments 6, 8 and of a thrust load transmission device 9 to transmit the loads generated by the turbojet engine 2, the mounting system 11 therefore being positioned between the engine and the above-mentioned rigid structure 10. By way of indication, it is noted that the assembly 1 is intended to be surrounded by a nacelle (not shown in this figure) and that the pylon 4 comprises another series of attachments (not shown) used to mount this assembly 1 below the aircraft wing.

In the following description, by convention, X designates the longitudinal direction of the pylon 4 comparable to the longitudinal direction of the turbojet engine 2, this direction X being parallel to a longitudinal axis 5 of this turbojet engine 2. Also, Y is used to designate the direction oriented transversely relative to the pylon 4 and comparable to the transverse direction of the turbojet engine 2, and Z is the vertical direction of height, these three directions X, Y and Z lying orthogonal to each other.

Also, the terms “forward” and “aft” are to be considered with respect to a direction of travel of the aircraft, subsequent to the thrust exerted by the turbojet engine 2, this direction being schematically illustrated by arrow 7.

In FIG. 1, it can be seen that only the load transmission device 9, the engine attachments 6, 8, and the rigid structure 10 of the pylon 4 are shown. The other constituent elements of this pylon 4 which are not shown, such as the mounting means for the rigid structure 10 below the aircraft wing, or the secondary structure ensuring the separation and supporting of the supply lines whilst carrying aerodynamic cowling, are conventional elements identical or similar to those found in the prior art, and known to the person skilled in the art. Therefore no detailed description thereof will be given.

The turbojet 2 forwardly has a fan case 12 of large size delimiting an annular fan duct 14, and aftwardly has a central case 16 of smaller size enclosing the core of this turbojet. Finally, the central case 16 is extended aftward by an exhaust case 17 of larger size than case 16. Cases 12, 16 and 17 are evidently joined to each other.

As can be seen FIG. 1, the plurality of engine attachments consists of a forward engine attachment 6 and an aft engine attachment 8, the forward attachment 6 being of conventional design and known in the prior art, namely of the type having an attachment body in the form of a bracket or beam on whose side ends two shackles/links are respectively hinged. The thrust load transmitting device 9 is in the form of two side links for example (only one can be seen since this is a side view) joined firstly to an aft part of the fan case 12 or to a forward part of the central case 16 and secondly a the rudder bar which itself is mounted on the aft attachment 8.

The forward engine attachment 6, whose positioning specific to the invention will be described below, is joined to the fan case 12, and is designed so that it is able to transmit the loads generated by the turbojet 2 in directions Y and Z, by means of two shackles/links. For indication, this forward attachment 6 preferably enters into a circumferential end portion of the fan case 12.

The aft engine attachment 8 is globally positioned between the exhaust case 17 and the rigid structure 10 of the pylon. It is conventionally designed so that it is able to transmit the loads generated by the turbojet 2 in directions Y and Z, but not those exerted in direction X.

In this way, with the mounting system 11 of isostatic type, as schematically illustrated FIG. 2, the loads exerted in direction X are transmitted by device 9, the loads exerted in direction Y are transmitted by the forward attachment 6 and aft attachment 8, and the loads exerted in direction Z are also jointly transmitted by attachments 6 and 8. Also, the moment exerted in direction X is transmitted vertically by the forward attachment 6, the moment exerted in direction Y is transmitted vertically by the forward attachment 6 jointly with attachment 8, and the moment exerted in direction Z is transmitted transversely also by attachment 6 and attachment 8.

Still with reference to FIG. 1, it can be seen that the structure 10 is in the form of a box structure extending in direction X, this box structure also being called a torque box. It is conventionally formed of an upper spar 26 and a lower spar 28 and of two side panels 30 (only one being visible FIG. 1) both extending in direction X and substantially along a plane XZ. Inside this box, transverse ribs 32 arranged along planes YZ and spaced longitudinally apart, reinforce the rigidity of the box. It is noted by way of indication that elements 26, 28, and 30 may each be made in a single piece, or by assembly of joined sections, which may optionally lie at a slight angle to each other. Nevertheless, one of the particular aspects here lies in the fact that the lower spar 28 extends over a plane that is inclined relative to the horizontal, over its entire length as shown FIG. 1.

The incline is such that the lower spar 28, parallel to direction Y, approaches axis 5 aftward, for the purpose of drawing close to the exhaust case 17 to allow installation of the aft engine attachment 8 carried by this spar 28.

Again with reference to FIG. 1 illustrating a case in which the engine 2 is intended to be mounted below the wing 3, provision is made for the structure 10 to be equipped with a forward closing rib 36 of the box, joining together the forward end 26a of the upper spar 26 and the forward end 28a of the lower spar 28. Directly above this rib 36 a tapered shim 34 is provided lying flat against the outer surface of the forward end 28a of the inclined lower spar 28, and fixedly mounted underneath this same spar, hence outwardly with respect to the box. The chief function of the tapered shim 34, by means of its lower portion, is to define a horizontal securing surface 38 intended to receive the attachment body of the forward engine attachment 6. More precisely, the surface 38 is intended to bear against and be fixedly mounted on a horizontal securing surface 40 of the attachment body of the forward engine attachment 6, also called the forward engine attachment beam 6, the two surfaces in contact 38, 40 therefore being substantially arranged along plane XY.

Therefore, the tapered shim 34 acts as interface between the inclined lower spar 28 and the forward engine attachment beam, and provides for compensation of the angle of the lower spar 28 and adjustment of the height between the rigid structure 10 and the beam of the forward engine attachment 6.

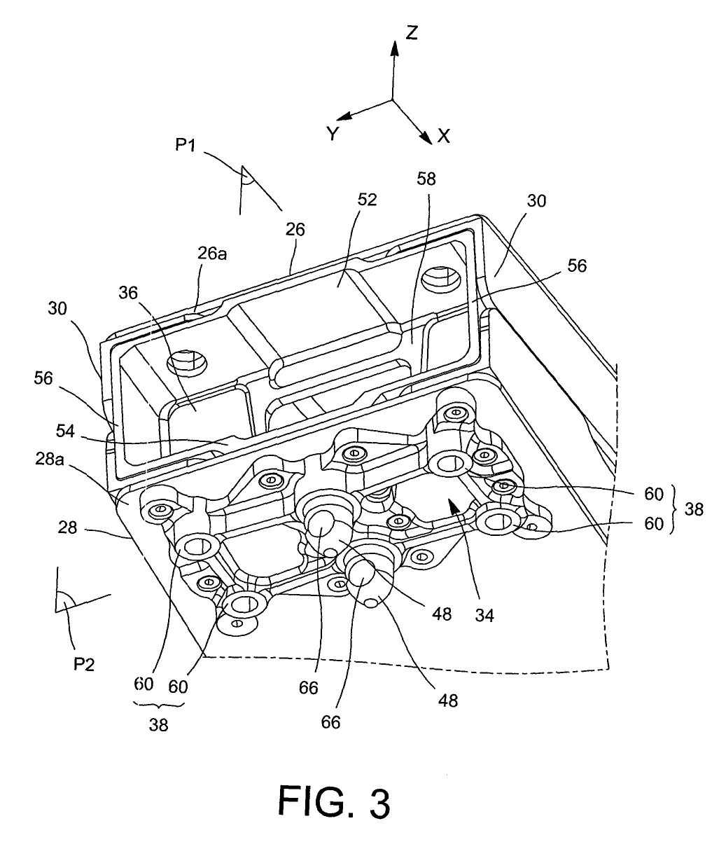

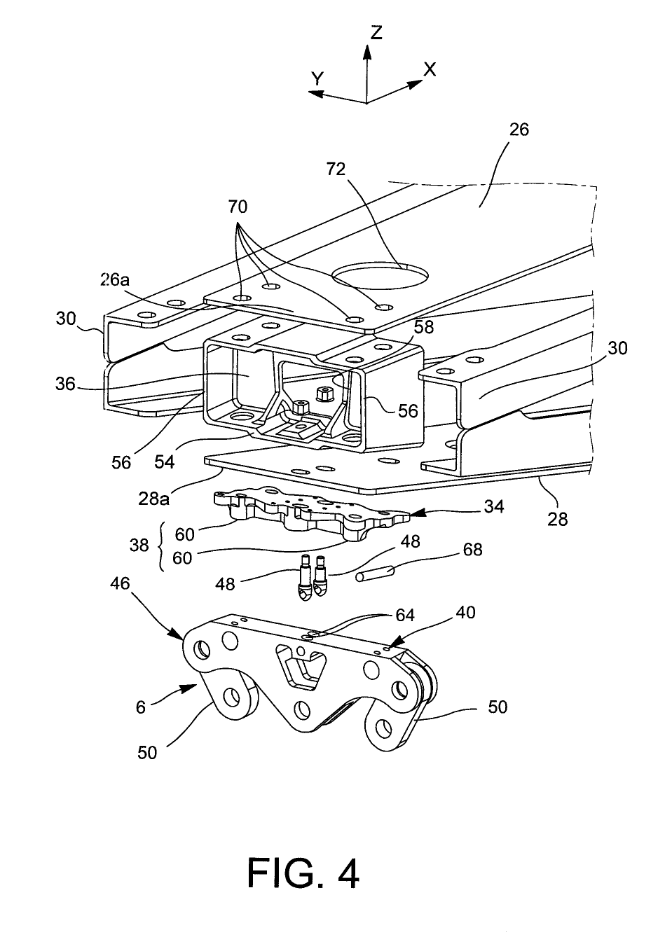

With reference now to FIGS. 3 to 6 showing the forward part of the pylon 4 in more detail, it can be seen that the forward closing rib 36 of the box is preferably in the shape of a square or rectangle, this rib 36 preferably being bored in its centre in direction X and oriented along plane YZ. Evidently, this rib 36 could alternatively be solid without departing from the scope of the invention.

It has an upper sidewall 52 in contact with the forward end 26a of the upper spar 26, and a lower sidewall 54 in contact with the forward end 28a of the lower spar 28. In addition, it has two sidewalls 56 respectively in contact with the two side panels 30, each of which may consist of two semi-spars as illustrated FIGS. 3, 4 and 6.

Alternatively, the two elements referenced 30 in the figures may be supporting plates for side panels positioned thereupon (but not shown) without departing from the scope of the invention. In said case, these plates 30 also act as support for the lower spar 28 and upper spar 26 of the rigid structure, as can be seen in the figures.

By way of indication, each of the above-mentioned sidewalls 56 extends longitudinally either side of a rib body 58, oriented transversely.

The shim 34 lies flat against and in contact with the outer surface of the forward end 28a of the lower spar 28, its lower surface comprising for example four bearing points 60 used to define the horizontal securing surface 38 of the rigid structure, against which the horizontal securing surface 40, defined by the attachment body 46 of the forward engine attachment, is intended to come into contact. The angle of the tapered shim 34 is set in relation to encountered needs, and typically is in the order of 5 to 15°. Evidently, this angle also corresponds to the angle between the lower spar and plane XY containing the engine axis 5.

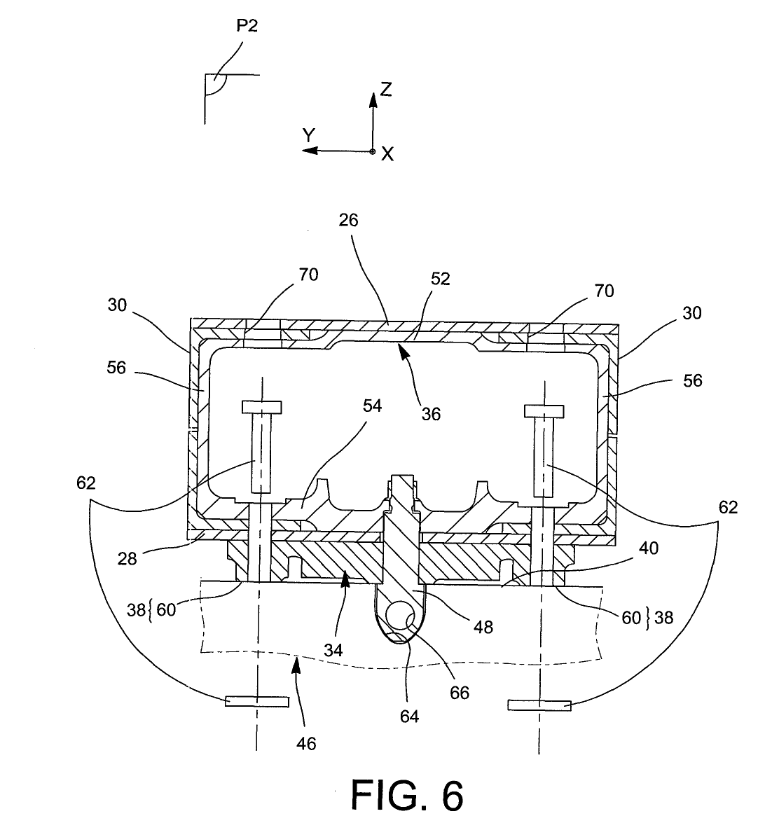

The forward engine attachment therefore comprises an attachment body 46 assuming the form of a bracket or beam oriented transversely and joined to the rigid structure 10, and more precisely to the horizontal securing surface 38 of the tapered shim 34. This is preferably achieved via vertical tension bolts 62 each successively passing through the attachment body 46, the tapered shim 34 at a bearing point 60, the inclined spar 28 and the lower sidewall 54 of the forward closing rib 36 of the box. By way of indication, it is noted that they may also pass through the end connection of the side panel 30 or supporting plate 30 lying between the lower sidewall 54 and the forward end 28a of the lower spar, as can be seen FIG. 6.

Therefore, four vertical tension bolts 62 are preferably provided, distributed either side of the rib body 58, and each passing through one of the four bearing points 60 acting to define the horizontal securing surface 38. These bolts 62 serve to transmit loads exerted in direction Z.

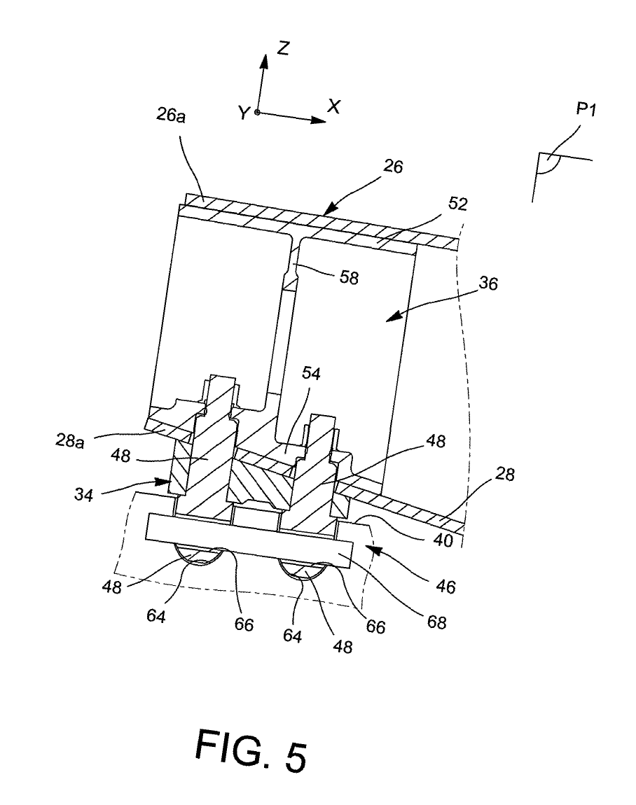

In addition, a vertical shear pin 48 passes through the above-mentioned elements, and lies in a plane XZ, called P1, corresponding to a plane of vertical symmetry for the rigid structure 10, and more generally for the pylon assembly. It ensures transmission of loads in direction Y. As shown in the figures, a second vertical shear pin 48 may be provided, mounted with clearance so as to ensure transmission of loads solely in the event of failure of the first pin 48. It is therefore capable, in addition to its positioning function for the beam 46 (rotational indexing), of ensuring the so-called “Fail Safe” function of load transmission in direction Y in the event of failure occurring on the main load pathway. The two pins 48, each housed in a housing 64 in the beam 46, one with clearance and the other without clearance, are preferably positioned either side of the rib body 58, as can be more clearly seen FIG. 5.

Additionally, in their lower part, they are each provided with an orifice 66 oriented longitudinally and through which one same dowel pin 68 passes with clearance, which also passes without clearance through the beam 46. Therefore, these shear pins 48 are also capable of ensuring the so-called “Fail Safe” function for transmission of loads in direction Z, in the event of failure of the tension bolts 62. However, no load along Z transits by this dowel pin 68 for as long as the main load pathway in this direction, consisting of the tension bolts 62, does not fail.

Finally, it is noted that conventional securing means of bolt type can be provided to ensure fixed assembly of the shim 36 on the spar 28, before placing the above-mentioned tension bolts 62 in position. It is effectively to be noted that the method to mount the engine assembly consists of bringing the engine 2 equipped with the attachment body 46 of the forward engine attachment 6 towards the rigid structure equipped with the tapered shim 34, then of placing in position the vertical tension bolts 62 in the appropriate orifices.

At the two side ends of the attachment body 46, the forward engine attachment has two clevises at which two shackles/links 50 are hinged, each of these partly forming a semi-attachment of the forward attachment through which loads exerted in direction Z are able to transit. In manner known to the person skilled in the art, these shackles 50 are also hinged at their other end on clevises also belonging to the forward attachment 6, fixedly added onto the fan case 12.

In this preferred embodiment, such as illustrated FIG. 5, the forward ends 26a and 28a are positioned approximately at one same level in direction X. Therefore, to allow clamping of the tension bolts 62, wells 70 are made through the upper part of the box, each well being vertically aligned with one of these bolts 62. Therefore, to clamp a bolt 62, the operator is able to insert tooling through the corresponding well 70, for example passing through the forward end 26a of the upper spar, the end connection of the side panel or the supporting plate 30, and the upper sidewall 52 of the rib as shown FIG. 6.

Finally, it is noted that access to the inside of the box is made possible by a manhole 72 of larger size made on the upper spar 26 and arranged aftward relative to the body 58 of the forward closing rib.

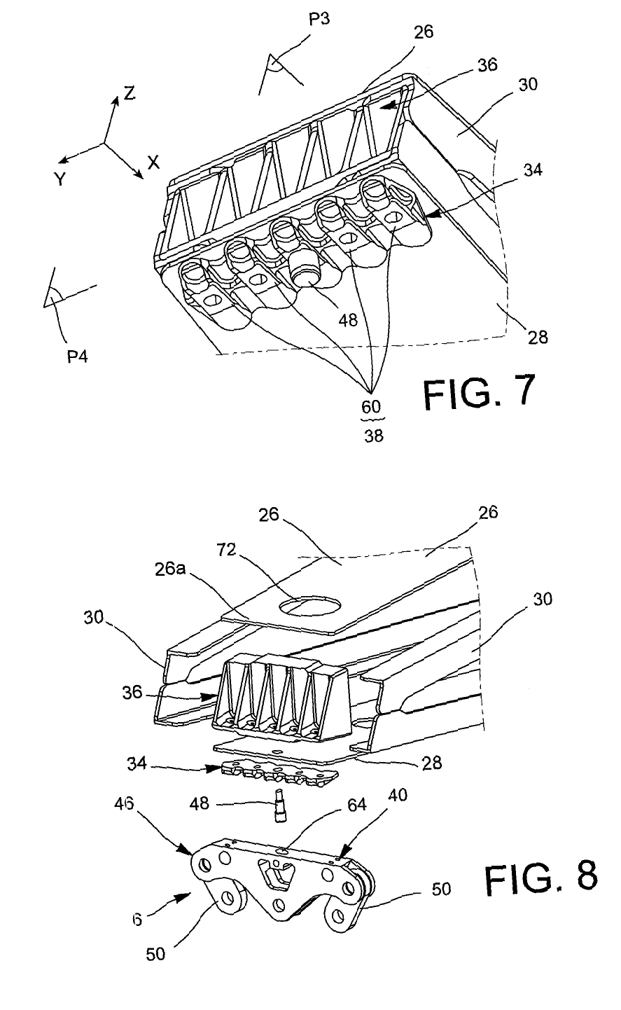

With reference now to FIGS. 7 to 10 showing in detail the forward part of a pylon 4 according to another preferred embodiment of the present invention, it can be seen that it is of similar design to the pylon described above. In this respect, those parts carrying the same reference numbers correspond to identical or similar parts.

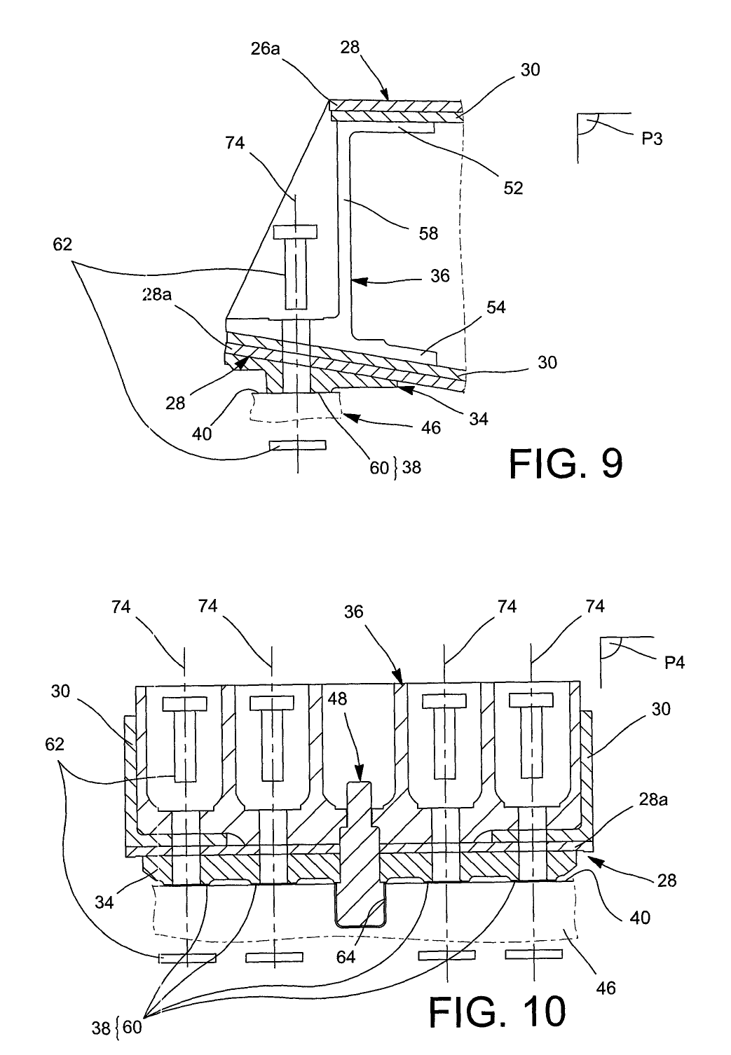

The main difference lies in the fact that the forward end 28a of the inclined lower spar 28 extends forwardly beyond the forward end 26a of the upper spar 26, as can be better seen FIG. 9. Therefore, provision is made for all four vertical tension bolts 62 to be arranged forwardly relative to the body 58 of the forward closing rib 36, so that the axes 74 of these bolts 62 pass through the forward end 28a but do not pass through the forward end 26a arranged further aftward. This enables a technician to clamp these bolts 62 easily from overhead, without being hindered by the upper spar 26, and more especially without having to insert tooling through some parts of the box. In particular, the wells 70 described previously are no longer necessary.

The four tension bolts 62 are therefore no longer arranged to form a square or rectangle as previously, but are aligned in direction Y along the vertical plane P4, as can be seen FIG. 10. Also, at least one vertical shear pin 48 is provided whose role is to ensure transmission of loads exerted in direction Y, this pin 48 preferably being aligned with the bolts 62 and again lying along plane XZ (not shown) corresponding to a vertical plane of symmetry for the rigid structure 10, and parallel to the vertical plane called P3 passing through one of the two tension bolts 62 respectively located at the ends of the transverse securing line.

With this configuration in which the shear pin 48, housed in a housing 64 of the attachment body 46, is preferably not equipped with a previously described dowel pin 68, the so-called “Fail Safe” function for transmission of loads in direction Z is ensured by the capability of each bolt 62 to cause loads to be transmitted in this same direction.

Also, an assembly may be provided with or without clearance of one of the vertical tension bolts 62, so as to ensure transmission of loads in direction Y solely in the event of failure of the single pin 48. Therefore, the bolt concerned is capable of ensuring the so-called “Fail Safe” function of transmitting loads in direction Y in the event of failure occurring on the main load pathway.

Evidently, various modifications may be made by the oerson skilled in the art to the aircraft engine assembly 1 just described solely as a non-limiting example. In this respect, it can notably be indicated that while the engine assembly 1 has been presented in a configuration adapted for its mounting below the wing of the aircraft, this assembly 1 could also have a different configuration allowing its mounting over this same wing.

1-12. (canceled)

13. A mounting pylon for an aircraft engine, the pylon comprising:
a rigid structure forming a box including a spar inclined from the horizontal; and
an engine mounting system fixedly mounted on the rigid structure and including a forward engine attachment including an attachment body including a horizontal securing surface lying flat against a horizontal securing surface of the rigid structure,
wherein the horizontal securing surface of the rigid structure is defined by a tapered shim mounted on the inclined spar externally relative to the box.

14. A pylon according to claim 13, wherein the rigid structure includes a forward closing rib of the box, and further comprising means for securing the tapered shim onto the inclined spar passing through the forward closing rib.

15. A pylon according to claim 14, wherein the securing means for the tapered shim onto the inclined spar includes vertical tension bolts successively passing through the attachment body, the tapered shim, the inclined spar, and the forward closing rib of the box.

16. A pylon according to claim 14, wherein the forward engine attachment includes at least one vertical shear pin successively passing through the attachment body, the tapered shim, the inclined spar, and the forward closing rib of the box.

17. A pylon according to claim 16, wherein the inclined spar forms a lower spar of the box.

18. A pylon according to claim 17, wherein the forward closing rib of the box includes a lower sidewall lying flat against a forward end of the inclined lower spar, and an upper sidewall lying flat against a forward end of an upper spar of the box-forming rigid structure.

19. A pylon according to claim 18, wherein the forward end of the inclined lower spar extends forwardly beyond the forward end of the upper spar, axes of the vertical tension bolts passing through the forward end of the inclined lower spar without passing through the forward end of the upper spar.

20. A pylon according to claim 13, wherein the forward engine attachment is configured to ensure transmission of loads exerted in a transverse direction of the pylon, and in a vertical direction thereof.

21. A pylon according to claim 13, wherein the engine mounting system further comprises a device to transmit thrust loads, and an aft engine attachment configured to ensure transmission of loads exerted in the transverse and vertical directions of the pylon.

22. A pylon according to claim 13, wherein the inclined spar is planar, from one end to the other of the rigid structure in a longitudinal direction of the pylon.

23. An aircraft engine assembly comprising:
a mounting pylon according to claim 13; and
an engine fixedly mounted on the pylon.

24. An aircraft comprising at least one engine assembly according to claim 23.
